(19) United States
(12) Patent Application Publication
(10) Pub. No.: US 2026/0032273 A1
(43) Pub. Date: Jan. 29, 2026

(54) DATA PROCESSING IN A ENCODING PROCESS

(71) Applicant: V-NOVA INTERNATIONAL LIMITED, London (GB)

(72) Inventors: Charvi MEHTA, London (GB); Max KOLESIN, London (GB)

(21) Appl. No.: 18/997,707

(22) PCT Filed: Jul. 21, 2023
(86) PCT No.: PCT/GB2023/051940

§ 371 Date: Jan. 22, 2025

(30) Foreign Application Priority Data
Jul. 22, 2022 (GB) 2210742.9

(51) Int. Cl. H04N 19/436; H04N 19/172; H04N 19/85

(52) U.S. Cl. CPC H04N 19/436; H04N 19/172; H04N 19/85

(57) ABSTRACT

There is provided a method of processing data as part of an encoding process for video data. The method comprising configuring a coprocessor to process data in parallel using pipelining. The pipelining being configured according to a processing scheme which comprises a plurality of processes that each perform a discrete function of the encoding process for video data. The data comprises a plurality of processing units. The method further comprises processing the data at the coprocessor so that the plurality of processing units are each processed by a corresponding one of the plurality of processes in parallel.

### TECHNICAL FIELD

The invention relates to a method for processing data using a coprocessor as part of an encoding process for video data. In particular, the invention relates to the use of a coprocessor for processing the data in parallel using pipelining. In particular, but not exclusively, the encoding process creates an encoded bitstream in accordance with MPEG5 Part 2 LCEVC standard using pipelining on the coprocessor. The invention is implementable in hardware or software.

### BACKGROUND

Latency and throughput are two important parameters for evaluating data encoding techniques used, for example, to encode video data. Latency is the time taken to produce an encoded frame after receipt of an original frame. Throughput is the time taken produce a second encoded frame after production of a first encoded frame.

Throughput of video data encoding may be improved by improving latency. However, improving latency is costly. As such, there is a need for an efficient and cost-effective method for improving the throughput of video encoding.

### SUMMARY

According to a first aspect of the invention, there is provided a method of processing data as part of an encoding process for video data. The method comprising configuring a coprocessor to process data in parallel using pipelining. The pipelining being configured according to a processing scheme which comprises a plurality of processes that each perform a discrete function of the encoding process for video data. The data comprises a plurality of processing units. The method further comprises processing the data at the coprocessor so that the plurality of processing units are each processed by a corresponding one of the plurality of processes in parallel. In this way, throughput of data processing can be significantly increased in an efficient and cost-effective manner.

Preferably, the coprocessor receives instructions from a main processor to perform the processing scheme.

Preferably, the main processor is a central processing unit (CPU) and the coprocessor is a graphical processing unit (GPU).

Preferably, the main processor instructs the coprocessor using a Vulkan API.

Preferably, the plurality of processes configured and performed on the coprocessor are processes in the encoding process prior to entropy encoding and wherein the coprocessor outputs the output from the final process of the processing scheme to the main processor for entropy encoding.

Preferably, the plurality of processes comprise one or more of: a convert process; an M-Filter process; a downsample process; a base encoder; a base decoder; a transport stream, TS complexity extraction process; a lookahead metrics extraction process; a perceptual analysis process; and an enhancement layer encoding process.

Preferably, the enhancement layer encoding process comprises one or more of the following processes: a first residual generating process to generate a first level of residual information; a second residual generating process to generate a second level of residual information; a temporal prediction process operating on the second level of residual information; one or more transform processes; and one or more quantisation processes.

Preferably, the first residual generating process comprises: a comparison of a downsampled version of a processing unit with a base encoded and decoded version of the processing unit.

Preferably, the second residual generating process comprises: a comparison of an input version of the processing unit with an upsampled version of the base encoded and decoded version of the processing unit corrected by the first level of residual information for that processing unit.

Preferably, the processing scheme offloads a base encoder and base decoder operation to a dedicated base codec hardware, and outputs a downsampled version of a processing unit to the dedicated base codec hardware and receives a base decoded version of the downsampled version after processing by the codec.

Preferably, the downsampled version is the lowest spatial resolution version in the encoding process.

Preferably, the processing scheme performs forward complexity prediction on a given processing unit while the base codec is working on the downsampled version of the given processing unit.

Preferably, the forward complexity prediction comprises one or more of the following processes: a transport stream, TS, complexity extraction process; a lookahead metrics extraction process; a perceptual analysis process.

Preferably, the processing scheme uses synchronisation primitives to ensure that shared resources are assigned to only one process at a time.

Preferably, the synchronisation primitives are semaphores.

Preferably, the semaphores are binary semaphores.

Preferably, earlier processes in the plurality of processes have a higher priority to any shared resources than later processes.

Preferably, the processing scheme uses a feedforward when done method so that earlier processes in the plurality of processes signal to the next process when that earlier process is complete.

Preferably, the feedforward when done method uses the synchronisation primitive.

Preferably, processes of the processing scheme with relatively more complex discrete functions have greater assigned resources in the coprocessor than processes of the processing scheme with relatively less complex discrete functions.

Preferably, the encoding process creates an encoded bitstream in accordance with MPEG5 Part 2 LCEVC standard.

Preferably, the processing unit is one of: a frame or picture; a block of data within a frame; a coding block; and a slice of data within a frame.

According to a second aspect of the invention, there is provided a coprocessor for encoding video data. The coprocessor is arranged to perform the method of any preceding statement.

According to a third aspect of the invention, there is provided a computer-readable medium comprising instructions which when executed cause a processor to perform the method of any preceding method statement.

### BRIEF DESCRIPTION OF THE DRAWINGS

The invention shall now be described, by way of example only, with reference to the accompanying drawings in which:

FIG. 1 is a block diagram of a hierarchical coding technology with which the principles of the present invention disclosure may be used;

FIG. 2 is a schematic diagram demonstrating pipelining operations at a coprocessor according to the present invention; and

FIG. 3 is a flow diagram of a method of processing data as part of an encoding process for video data according to the present invention.

### DETAILED DESCRIPTION

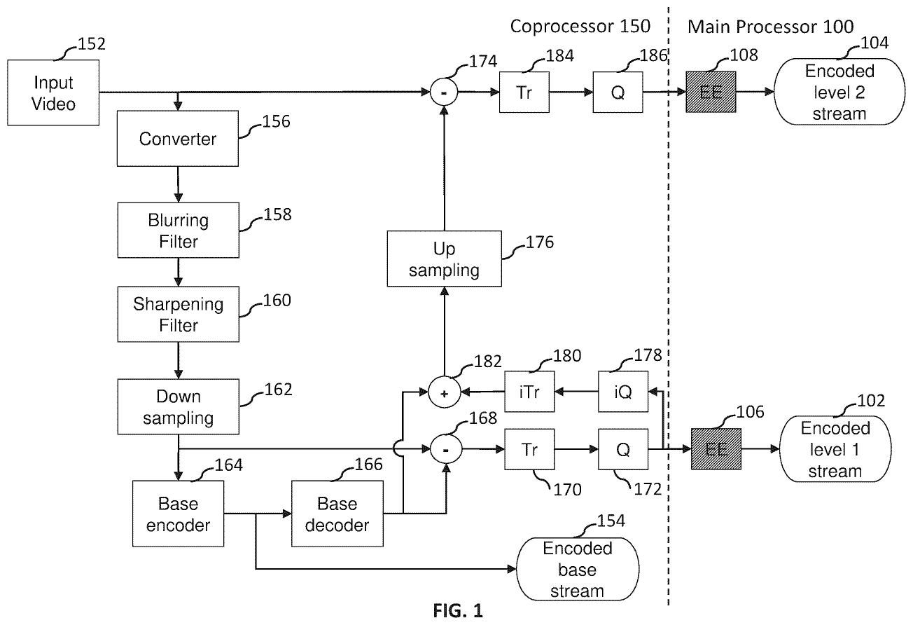

FIG. 1 is a block diagram of a hierarchical coding technology which implements the present invention. The hierarchical coding technology of FIG. 1 is in accordance with MPEG5 Part 2 Low Complexity Enhancement Video Coding (LCEVC) standard (ISO/IEC 23094-2:2021(en)). LCEVC is a flexible, adaptable, highly efficient and computationally inexpensive coding technique which combines a base codec, (e.g., AVC, HEVC, or any other present or future codec) with another different encoding format providing at least two enhancement levels of coded data.

In the example of FIG. 1, some of the processes of LCEVC are done in a main processor 100, e.g., a central processing unit (CPU) and other processes are done in a coprocessor 150 e.g., a graphical processing unit (GPU). A coprocessor 150 is a computer processor used to supplement the functions of the main processor 100 (the CPU). Operations performed by the coprocessor 150 may be floating-point arithmetic, graphics, signal processing, string processing, cryptography or I/O interfacing with peripheral devices. By offloading processor-intensive tasks from the main processor 100, coprocessors can accelerate system performance. The coprocessor 150 referred to in this application is not limited to a GPU, rather it can be appreciated that any coprocessor with parallel operation capability may be suitable for performing the invention.

By splitting the processes of LCEVC between a main processor 100 and a coprocessor 150, the LCEVC can be improved by leveraging parallel operations of a coprocessor 150, such as a GPU. Performing processes of LCEVC in parallel increases throughput of video encoding. It takes time and resources to initialise a coprocessor 150. Therefore, the time and resource used to initialise should be regained by taking advantage of efficient use of the coprocessor 150. In other words, it is not always efficient to initialise the coprocessor 150 for video encoding unless parallelisation is used in the coprocessor 150.

The coprocessor 150 is configured by receiving instructions from the main processor 100 to perform a processing scheme as part of an overall encoding process. The main processor 100 may instruct the coprocessor 150 to perform a processing scheme using a Vulkan API which provides a consistent way for interacting with coprocessors from different manufacturers. However, it can be appreciated that other APIs may be used.

Some processes of the processing scheme perform a discrete function on a processing unit such as a frame, residual frame, slice, tile or block of data so that the processing unit is prepared or further processed. Some processes depend on the output of another process and must wait until the another process has completed processing the processing unit.

In general, the encoding process shown in FIG. 1 creates a converted, pre-processed and a down-sampled source signal encoded with a base codec, adds a first level of correction data to the decoded output of the base codec to generate a corrected picture, and then adds a further level of enhancement data to an up-sampled version of the corrected picture.

Specifically, an input video 152, such as video at an initial resolution, is received and is converted at converter 156. Converter 156 converts input video 152 from an input signal format (RGB etc) and colorspace (sRGB etc) to a format and colorspace supported by the encoding process, e.g., (YUV420p and BT709, BT2020 etc).

The converted input signal is pre-processed by applying a blurring filter 158 and a sharpening filter 160 (collectively known as an M filter). Then, the pre-processed input video signal is downsampled by downsampler 162. A first encoded stream (encoded base stream 154) is produced by feeding a base codec (e.g., AVC, HEVC, or any other codec) with the converted, pre-processed and down-sampled version of the input video 152. The encoded base stream 154 may be referred to as a base layer or base level.

A second encoded stream (encoded level 1 stream 102) is produced by processing residuals obtained by taking the difference between a reconstructed base codec signal and the downsampled version of the input video 152. A third encoded stream (encoded level 2 stream 104) is produced by processing residuals obtained by taking the difference between an upsampled version of a corrected version of the reconstructed base coded video and the input video 152. In certain cases, the components of FIG. 1 may provide a general low complexity encoder. In certain cases, the enhancement streams may be generated by encoding processes that form part of the low complexity encoder and the low complexity encoder may be configured to control an independent base encoder 164 and decoder 166 (e.g., as packaged as a base codec). In other cases, the base encoder 164 and decoder 166 may be supplied as part of the low complexity encoder. In one case, the low complexity encoder of FIG. 1 may be seen as a form of wrapper for the base codec, where the functionality of the base codec may be hidden from an entity implementing the low complexity encoder.

Looking at the process of generating the enhancement streams in more detail, to generate the encoded Level 1 stream 102, the encoded base stream is decoded by the base decoder 166 (i.e. a decoding operation is applied to the encoded base stream 154 to generate a decoded base stream). Decoding may be performed by a decoding function or mode of a base codec. The difference between the decoded base stream and the down-sampled input video is then created at a level 1 comparator 168 (i.e. a subtraction operation is applied to the down-sampled input video 152 and the decoded base stream to generate a first set of residuals). The output of the comparator 168 may be referred to as a first set of residuals, e.g. a surface or frame of residual data, where a residual value is determined for each picture element at the resolution of the base encoder 164, the base decoder 166 and the output of the downsampling block 162.

The difference is then transformed, quantised and entropy encoded at transformation block 170, quantisation block 172 and entropy encoding block 106 respectively to generate the encoded Level 1 stream 102 (i.e. an encoding operation is applied to the first set of residuals to generate a first enhancement stream). The transformation and quantisation processes occur in the coprocessor 150. Post quantisation, the coprocessor 150 passes the processed data to the main processor 100 in which entropy encoding occurs.

As noted above, the enhancement stream may comprise a first level of enhancement and a second level of enhancement. The first level of enhancement may be considered to be a corrected stream, e.g. a stream that provides a level of correction to the base encoded/decoded video signal at a lower resolution than the input video 152. The second level of enhancement may be considered to be a further level of enhancement that converts the corrected stream to the original input video 152, e.g. that applies a level of enhancement or correction to a signal that is reconstructed from the corrected stream.

In the example of FIG. 1, the second level of enhancement is created by encoding a further set of residuals. The further set of residuals are generated by a level 2 comparator 174. The level 2 comparator 174 determines a difference between an upsampled version of a decoded level 1 stream, e.g. the output of an upsampling block 176, and the input video 152. The input to the up-sampling block 176 is generated by applying an inverse quantisation and inverse transformation at an inverse quantisation block 178 and an inverse transformation block 180 respectively to the output of the quantisation block 172. This generates a decoded set of level 1 residuals. These are then combined with the output of the base decoder 166 at summation component 182. This effectively applies the level 1 residuals to the output of the base decoder 166. It allows for losses in the level 1 encoding and decoding process to be corrected by the level 2 residuals. The output of summation component 182 may be seen as a simulated signal that represents an output of applying level 1 processing to the encoded base stream 154 and the encoded level 1 stream 102 at a decoder.

As noted, an upsampled stream is compared to the input video 152 which creates a further set of residuals (i.e. a difference operation is applied to the upsampled re-created stream to generate a further set of residuals). The further set of residuals are then transformed, quantised and entropy encoded at transformation block 184, quantisation block 186 and entropy encoding block 108 respectively to generate the encoded level 2 enhancement stream (i.e. an encoding operation is then applied to the further set of residuals to generate an encoded further enhancement stream).

Thus, as illustrated in FIG. 1 and described above, the output of the encoding process is a base stream and one or more enhancement streams, which preferably comprise a first level of enhancement and a further level of enhancement. The three streams may be combined, with or without additional information such as control headers, to generate a combined stream for the video encoding framework that represents the input video 152. It should be noted that the components shown in FIG. 1 may operate on a slice of data within a frame, a tile, or blocks or coding units of data, e.g. corresponding to 2×2 or 4×4 portions of a frame at a particular level of resolution. The components operate without any inter-processing unit dependencies, hence they may be applied in parallel to multiple slices, tiles, blocks or coding units within a frame. This differs from comparative video encoding schemes wherein there are dependencies between processing units such as blocks (e.g., either spatial dependencies or temporal dependencies). The dependencies of comparative video encoding schemes limit the level of parallelism and require a much higher complexity.

To make use of parallelism, much of the processes in FIG. 1 are implemented in a coprocessor 150. The coprocessor 150 of FIG. 1 processes the input video 152 in parallel using pipelining which allows for multiple processes to occur at the same time, e.g., while a downsampling process is being applied to data #n, an M filtering process may be applied to data #n+1 at the same time. In this way, the throughput of video encoding can be increased.

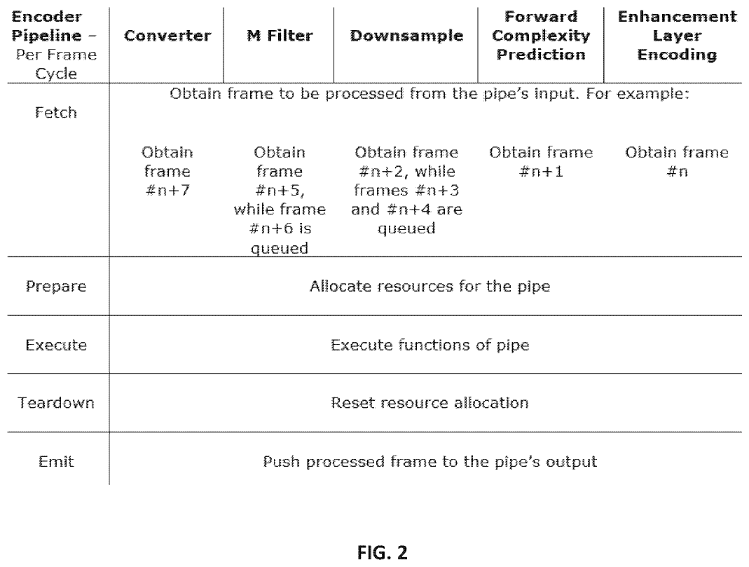

FIG. 2 is a schematic diagram demonstrating pipelining operations at a coprocessor according to the present invention. In the example of FIG. 2, the coprocessor receives data to process as part of an encoding process for video data. In this example, the data received is frame data from a video signal, however, other types of data may be received for example a slice of data within a frame, tiles, blocks or coding units of data.

The coprocessor 150 comprises five encoder pipelines which perform five processes as shown in the uppermost vertical row. The processes are: a converter process, an M Filter process, a downsampling process, a forward complexity prediction process and an enhancement layer encoding process. Other types of processes or a different combination of processes may also be used. Each process shown in FIG. 2 comprises its own discrete function which it applies to the data it is processing.

Each process in the encoder pipeline goes through five operations per frame cycle. The five operations are shown on the left most column. The five operations are: fetch, prepare, execute, teardown and emit.

During the fetch operation, each process obtains (not necessarily at the same time) a frame to be processed. Each process has an input queue and during the fetch operation the next frame in the input queue is obtained. The input queue is configured during initialisation of the processing scheme that is to implement the encoding process. The example of FIG. 2 shows the following fetches: the converter process obtains frame #n+7 from its input queue; the M filter process obtains frame #n+5, while frame #n+6 is queued; the downsample process obtains frame #n+2, while frame n+3 and n+4 are queued; the forward complexity prediction process obtains frame #n+1; and the enhancements layer encoding process obtains frame #n. Some frames are queued because different processes operate at different speeds. Therefore, if a previous process finishes processing a first data while a subsequent process has not finished processing a second data yet, then the first data will be queued to be processed when the subsequent frame is ready i.e., after processing the second data.

In some examples, the processing scheme at the coprocessor uses synchronisation primitives to ensure that shared resources such as frame data stored in shared memory are assigned to only one process at a time. The synchronisation primitives are semaphores. The semaphores are binary semaphores. Earlier processes in the processing scheme have a higher priority to access any shared resources such as frame data stored in shared memory than later processes. The processing scheme uses a feedforward when done method so that earlier processes in the plurality of processes signal to the next process when that earlier process is complete. The feedforward when done method uses the synchronisation primitive.

During the prepare operation, resources are allocated for each process. During the execute operation, the functions of each process are executed in the respective data on each process. During the teardown operation, the resource allocation is reset. During the emit operation, the processed frames are outputted for each process.

Using the above parallel operations in a coprocessor, throughput of data processing can be significantly increased. For example, if a coprocessor receives data that includes five processing units (e.g., five frames) which are to be processed using five processes.

Typically, for five processing units to be processed using five processes, twenty-five time cycles (e.g., frame cycles) would be necessary. However, by performing the processes in the coprocessor in parallel using pipelining, the time cycles can be reduced to nine.

In this example, the pipeline process for forward complexity prediction in the coprocessor may occur at substantially the same time as the base codec of FIG. 1 operates and may operate on the same data the base codec operates in. Alternatively, the forward complexity prediction pipeline may occur at a different time, for example, before the downsampling process. The forward complexity prediction comprises one or more of the following processes: a transport stream (TS) complexity extraction process, a lookahead metrics extraction process and a perceptual analysis process.

The processes shown in FIG. 1 and FIG. 2 with relatively more complex discrete functions may have greater assigned resources in the coprocessor than processes of the processing scheme with relatively less complex discrete functions so that processes which usually take longer to complete can be performed more quickly due to efficient assignment of resources.

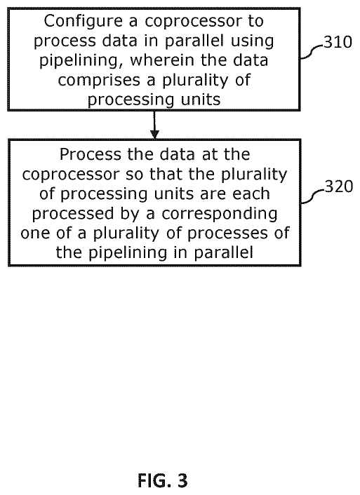

FIG. 3 is a flow diagram of a method of processing data as part of an encoding process for video data according to the present invention. At step 310, the method configures a coprocessor to process data in parallel using pipelining, wherein the data comprises a plurality of processing units. At step 320, the method processes the data at the coprocessor so that the plurality of processing units are each processed by a corresponding one of a plurality of process of the pipelining in parallel.

The above embodiments are to be understood as illustrative examples. Further embodiments are envisaged. It is to be understood that any feature described in relation to any one embodiment may be used alone or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

In the example of FIG. 1, the low complexity encoder is spread between a main processor 100 and a coprocessor 150 such that both processors operate together to perform the overall low complexity encoding. The base codec is a dedicated hardware device implemented in the coprocessor 150 to perform base encoding/decoding quickly. Alternatively, the base codec may be a computer program code that is executed by the coprocessor 150.

In certain cases, the base stream and the enhancement stream may be transmitted separately. References to an encoded data as described herein may refer to the enhancement stream or a combination of the base stream and the enhancement stream. The base stream may be decoded by a hardware decoder while the enhancement stream may be suitable for software processing implementation with suitable power consumption. This general encoding structure creates a plurality of degrees of freedom that allow great flexibility and adaptability to many situations, thus making the coding format suitable for many use cases including OTT transmission, live streaming, live ultra-high-definition UHD broadcast, and so on. Although the decoded output of the base codec is not intended for viewing, it is a fully decoded video at a lower resolution, making the output compatible with existing decoders and, where considered suitable, also usable as a lower resolution output.

In certain examples, each or both enhancement streams may be encapsulated into one or more enhancement bitstreams using a set of Network Abstraction Layer Units (NALUs). The NALUs are meant to encapsulate the enhancement bitstream in order to apply the enhancement to the correct base reconstructed frame. The NALU may for example contain a reference index to the NALU containing the base decoder reconstructed frame bitstream to which the enhancement has to be applied. In this way, the enhancement can be synchronised to the base stream and the frames of each bitstream combined to produce the decoded output video (i.e. the residuals of each frame of enhancement level are combined with the frame of the base decoded stream). A group of pictures may represent multiple NALUS.

The skilled person will understand from this disclosure that the encoding of video data in the way disclosed is not graphics rendering, nor is the disclosure related to transcoding. Instead, the video encoding disclosed relates to the creation of an encoded video stream from an input video source.

### Definitions and Terms

In certain examples described herein the following terms are used:
“access unit”—this refers to a set of Network Abstraction Layer Units (NALUs) that are associated with each other according to a specified classification rule. They may be consecutive in decoding order and contain a coded picture (i.e. frame) of video (in certain cases exactly one).
“base layer”—this is a layer pertaining to a coded base picture, where the “base” refers to a codec that receives processed input video data. It may pertain to a portion of a bitstream that relates to the base.
“bitstream”—this is sequence of bits, which may be supplied in the form of a NAL unit stream or a byte stream. It may form a representation of coded pictures and associated data forming one or more coded video sequences (CVSs).
“block”—an M×N (M-column by N-row) array of samples, or an M×N array of transform coefficients. The term “coding unit” or “coding block” is also used to refer to an M×N array of samples. These terms may be used to refer to sets of picture elements (e.g. values for pixels of a particular colour channel), sets of residual elements, sets of values that represent processed residual elements and/or sets of encoded values. The term “coding unit” is sometimes used to refer to a coding block of luma samples or a coding block of chroma samples of a picture that has three sample arrays, or a coding block of samples of a monochrome picture or a picture that is coded using three separate colour planes and syntax structures used to code the samples. A coding unit may comprise an M by N array R of elements with elements R[x][y]. For a 2×2 coding unit, there may be 4 elements. For a 4×4 coding unit, there may be 16 elements.
“chroma”—this is used as an adjective to specify that a sample array or single sample is representing a colour signal. This may be one of the two colour difference signals related to the primary colours, e.g. as represented by the symbols Cb and Cr. It may also be used to refer to channels within a set of colour channels that provide information on the colouring of a picture. The term chroma is used rather than the term chrominance in order to avoid the implication of the use of linear light transfer characteristics that is often associated with the term chrominance.
“coded picture”—this is used to refer to a set of coding units that represent a coded representation of a picture.
“coded base picture”—this may refer to a coded representation of a picture encoded using a base encoding process that is separate (and often differs from) an enhancement encoding process.
“coded representation”—a data element as represented in its coded form
“decoded base picture”—this is used to refer to a decoded picture derived by decoding a coded base picture.
“decoded picture”—a decoded picture may be derived by decoding a coded picture. A decoded picture may be either a decoded frame, or a decoded field. A decoded field may be either a decoded top field or a decoded bottom field.
“decoder”—equipment or a device that embodies a decoding process.
“decoding order”—this may refer to an order in which syntax elements are processed by the decoding process.
“decoding process”—this is used to refer to a process that reads a bitstream and derives decoded pictures from it.
“encoder”—equipment or a device that embodies a encoding process.
“encoding process”—this is used to refer to a process that produces a bitstream (i.e. an encoded bitstream).
“enhancement layer”—this is a layer pertaining to a coded enhancement data, where the enhancement data is used to enhance the “base”. It may pertain to a portion of a bitstream that comprises planes of residual data. The singular term is used to refer to encoding and/or decoding processes that are distinguished from the “base” encoding and/or decoding processes.
“enhancement sub-layer”—in certain examples, the enhancement layer comprises multiple sub-layers. For example, the first and second levels described below are “enhancement sub-layers” that are seen as layers of the enhancement layer.
“video frame or frame”—in certain examples a video frame may comprise a frame composed of an array of luma samples in monochrome format or an array of luma samples and two corresponding arrays of chroma samples. The luma and chroma samples may be supplied in 4:2:0, 4:2:2, and 4:4:4 colour formats (amongst others). A frame may consist of two fields, a top field and a bottom field (e.g. these terms may be used in the context of interlaced video). References to a “frame” in these examples may also refer to a frame for a particular plane, e.g. where separate frames of residuals are generated for each of YUV planes. As such the terms “plane” and “frame” may be used interchangeably.
“layer”—this term is used in certain examples to refer to one of a set of syntactical structures in a non-branching hierarchical relationship, e.g. as used when referring to the “base” and “enhancement” layers, or the two (sub-) “layers” of the enhancement layer.
“luma”—this term is used as an adjective to specify a sample array or single sample that represents a lightness or monochrome signal, e.g. as related to the primary colours. Luma samples may be represented by the symbol or subscript Y or L. The term “luma” is used rather than the term luminance in order to avoid the implication of the use of linear light transfer characteristics that is often associated with the term luminance. The symbol L is sometimes used instead of the symbol Y to avoid confusion with the symbol y as used for vertical location.
“network abstraction layer (NAL) unit (NALU)”—this is a syntax structure containing an indication of the type of data to follow and bytes containing that data in the form of a raw byte sequence payload (RBSP). The RBSP is a syntax structure containing an integer number of bytes that is encapsulated in a NAL unit. An RBSP is either empty or has the form of a string of data bits containing syntax elements followed by an RBSP stop bit and followed by zero or more subsequent bits equal to 0. The RBSP may be interspersed as necessary with emulation prevention bytes.
“network abstraction layer (NAL) unit stream”—a sequence of NAL units.
“picture”—this is used as a collective term for a field or a frame. In certain cases, the terms frame and picture are used interchangeably.
“residual”—this term is defined in further examples below. It generally refers to a difference between a reconstructed version of a sample or data element and a reference of that same sample or data element.
“residual plane”—this term is used to refer to a collection of residuals, e.g. that are organised in a plane structure that is analogous to a colour component plane. A residual plane may comprise a plurality of residuals (i.e. residual picture elements) that may be array elements with a value (e.g. an integer value).
“slice—a slice is a spatially distinct region of a frame that is encoded separately from any other region in the same frame.
“source”—this term is used in certain examples to describe the video material or some of its attributes before encoding.
“tile”—this term is used in certain examples to refer to a rectangular region of blocks or coding units within a particular picture, e.g. it may refer to an area of a frame that contains a plurality of coding units where the size of the coding unit is set based on an applied transform. For example, a tile may be made up of an 8×8 array of blocks/coding units. If the blocks/coding units are 4×4, this means that each tile has 32×32 elements; if the blocks/coding units are 2×2, this means that each tile has 16×16 elements.
“transform coefficient” (or just “coefficient”)—this term is used to refer to a value that is produced when a transformation is applied to a residual or data derived from a residual (e.g. a processed residual). It may be a scalar quantity, that is considered to be in a transformed domain. In one case, an M by N coding unit may be flattened into an M*N one-dimensional array. In this case, a transformation may comprise a multiplication of the one-dimensional array with an M by N transformation matrix. In this case, an output may comprise another (flattened) M*N one-dimensional array. In this output, each element may relate to a different “coefficient”, e.g. for a 2×2 coding unit there may be 4 different types of coefficient. As such, the term “coefficient” may also be associated with a particular index in an inverse transform part of the decoding process, e.g. a particular index in the aforementioned one-dimensional array that represented transformed residuals.

1-23. (canceled)

24. A method of processing a video frame as part of an encoding process for video data, the method comprising:
configuring a coprocessor to process a video frame, the video frame comprising a plurality of blocks, in parallel using pipelining, the pipelining being configured according to a processing scheme which comprises a plurality of processes that each perform a discrete function of the encoding process on the plurality blocks of the video frame; and
processing the video frame at the coprocessor so that a plurality of the blocks are processed by a corresponding one of the plurality of processes in parallel;
wherein the plurality of processes are processes in the encoding process prior to entropy encoding.

25. The method of claim 24, wherein the coprocessor receives instructions from a main processor to perform the processing scheme.

26. The method of claim 25, wherein the main processor is a central processing unit, CPU, and the coprocessor is a graphical processing unit, GPU.

27. The method of claim 25, wherein the main processor instructs the coprocessor using a Vulkan APL

28. The method of claim 25, wherein the coprocessor outputs the output from the final process of the processing scheme to the main processor for entropy encoding.

29. The method of claim 24, wherein the plurality of processes comprise one or more of: a convert process; an M-Filter process; a downsample process; a base encoder; a base decoder; a transport stream, TS complexity extraction process; a lookahead metrics extraction process; a perceptual analysis process; and an enhancement layer encoding process.

30. The method of claim 29, wherein the enhancement layer encoding process comprises one or more of the following processes: a first residual generating process to generate a first level of residual information; a second residual generating process to generate a second level of residual information; a temporal prediction process operating on the second level of residual information; one or more transform processes; and one or more quantisation processes.

31. The method of claim 30, wherein the first residual generating process comprises: a comparison of a downsampled version of a block with a base encoded and decoded version of the block.

32. The method of claim 31, wherein the second residual generating process comprises: a comparison of an input version of the block with an upsampled version of the base encoded and decoded version of the block corrected by the first level of residual information for that block.

33. The method of claim 24, wherein the processing scheme offloads a base encoder and base decoder operation to a dedicated base codec hardware, and outputs a downsampled version of a block to the dedicated base codec hardware and receives a base decoded version of the downsampled version after processing by the codec.

34. The method of claim 33, wherein the downsampled version is the lowest spatial resolution version in the encoding process.

35. The method of claim 33, wherein the processing scheme performs forward complexity prediction on a given block while the base codec is working on the downsampled version of the given block.

36. The method of claim 35, wherein the forward complexity prediction comprises one or more of the following processes: a transport stream, TS complexity extraction process; a lookahead metrics extraction process; a perceptual analysis process.

37. The method of claim 24, wherein the processing scheme uses synchronisation primitives to ensure that shared resources are assigned to only one process at a time.

38. The method of claim 37, wherein the synchronisation primitives are semaphores and wherein the semaphores are binary semaphores.

39. The method claim 37, wherein earlier processes in the plurality of processes have a higher priority to any shared resources than later processes, wherein the processing scheme uses a feedforward when done method so that earlier processes in the plurality of processes signal to the next process when that earlier process is complete, and wherein the feedforward when done method uses the synchronisation primitive.

40. The method of claim 24, wherein processes of the processing scheme with relatively more complex discrete functions have greater assigned resources in the coprocessor than processes of the processing scheme with relatively less complex discrete functions.

41. The method of claim 24, wherein the encoding process creates an encoded bitstream in accordance with MPEGS Part 2 LCEVC standard.

42. A coprocessor for encoding video data, wherein the coprocessor is configured to perform the following:
process a video frame, the video frame comprising a plurality of blocks, in parallel using pipelining, the pipelining being configured according to a processing scheme which comprises a plurality of processes that each perform a discrete function of the encoding process on the plurality blocks of the video frame; and
processing the video frame at the coprocessor so that a plurality of the blocks are processed by a corresponding one of the plurality of processes in parallel;
wherein the plurality of processes are processes in the encoding process prior to entropy encoding.

43. A non-transitory computer-readable medium comprising instructions which when executed cause a processor to perform the following operations:
configuring a coprocessor to process a video frame, the video frame comprising a plurality of blocks, in parallel using pipelining, the pipelining being configured according to a processing scheme which comprises a plurality of processes that each perform a discrete function of the encoding process on the plurality blocks of the video frame; and
processing the video frame at the coprocessor so that a plurality of the blocks are processed by a corresponding one of the plurality of processes in parallel;
wherein the plurality of processes are processes in the encoding process prior to entropy encoding.
